(19) United States
(12) Patent Application Publication
(10) Pub. No.: US 2002/0042812 A1
(43) Pub. Date: Apr. 11, 2002

(54) Apparatus, method and system for voice over a network having provider selection and disputeless billing

(76) Inventor: Mark A. Spencer, Madison, AL (US)

Correspondence Address: Curtis W. Dodd, 2803 Bentley Street, Huntsville, AL, 35801, US

(21) Appl. No.: 10/008,208

(22) Filed: Nov. 3, 2001

Related U.S. Application Data
(60) Provisional application No. 60/204,211, filed on May 12, 2000.

(51) Int. Cl. G06F 15/173

(52) U.S. Cl. 709/203; 709/223

(57) ABSTRACT

An apparatus and method are disclosed for providing telephone connectivity over a network having a plurality of entities coupled to the network. A provider is an entity that has chosen to be a member of a selectable entity that may be chosen to provide a telephone connection. A client, using a selection criteria, selects a provider from a plurality of providers.

### PRIORITY APPLICATION

This application claims priority to United States Provisional Application Serial No. 60/204,211 filed on Nov. 3, 2000, entitled “APPARATUS, METHOD AND SYSTEM FOR VOICE OVER A NETWORK HAVING PROVIDER SELECTION.”

### FIELD OF THE INVENTION

The present invention relates, in general, to providing voice service over a network having a plurality of customers and service providers.

### BACKGROUND

During the past several years, much attention has been focused on implementing various aspects of telephony using the Internet. The Internet, a DARPA government funded project, has become the largest network in existence with millions of computers and tens of millions of users worldwide.

Most Internet users obtain access to the Internet using an Internet Service Provider (ISP). Typically, the ISP purchases high-speed links to a number of “higher tier” providers, who in turn peer with one another, forming the backbone of the Internet. The ISP provides connections to the backbone of the Internet for both business and consumers users.

Typically Internet consumer users have been connected and still make a connection to the ISP through a dialup modem. Business Internet users may be connected local area network (LAN) that is coupled to the Internet over a high-speed link, such as a T1 link. In addition many businesses have a server coupled to the Internet to allow customers and others to gather information about products and services of the business. Other servers may be located at the ISP site and provide a way for customers to have websites etc.

The Internet may serve as part of a connection to provide phone service, often referred to as Voice over IP (VolP). Traditional implementations of VolP suffer from performance issues related to the uncertainty of the quality of the connection over the Internet.

Because the ISP business is very competitive, prices for an Internet connection have been pushed low. Typically, for customer satisfaction, an ISP must lease enough telephone lines to support access for the number of users requesting a connection at peak time, usually early evenings. Because leasing a large number of lines is a large fixed cost, the profit margin for an ISP is small. Further the leased lines are idle most of the day and do not generate revenue. On the other hand most business connections to the Internet are busy during the day and idle in the evenings

It would be of benefit to a provider or a business with excess capacity during certain periods of the day to offer the capacity for phone service. Both the provider, or business, and the consumer or user would benefit from such an arrangement.

### SUMMARY OF THE INVENTION

Because providers and businesses may have excess data bandwidth or capacity during certain times of the day, they may choose to offer the excess capacity to other users. By attractively pricing the excess capacity, both the bandwidth owner and the consumer may receive a benefit. When the bandwidth owner elects to offer their excess bandwith for VolP, the owner is referred to as a provider.

The present invention in one embodiment is a method of providing a telephone connection to a phone number over a network from a client connected to the network, the method comprising the steps of sending the phone number and an information request from the client to a central server. The central server then provides to the client, addresses of one or more providers and the requested information. One of the providers is then selected by the client, becoming the best provider, in accordance with a selection criteria. Next, a network voice path to the phone number through the address of the best provider is established.

In another embodiment for providing a voice connection over a network from a client site an apparatus comprises a data communication device, a central server and selection logic. The data communication device at the client site provides full duplex data transfers to the network, the data communication device configured to request information from other devices on the network. The central server is coupled to the network and configured for sending requested provider information related to one or more providers to the data communication device where provider information includes unit cost information and an address for each provider. Selection logic within the client to determine the best provider and establishes a voice service connection to a phone number.

A further embodiment of providing phone service to a client over a network includes a disputeless billing process, a method for the further embodiment starts with the step of the client requesting from a central server, provider information about one or more providers, where each of the providers is capable of connecting to a phone number furnished by the client. The client then determines the best provider from the one or more providers and establishes a connection. The billing process for the service furnished by the provider includes the steps of sending a payment ticket to the central server signed by a client private key, verifying with a client public key the validity of the payment ticket; and forwarding the payment ticket to the best provider.

### BRIEF DESCRIPTION OF THE DRAWINGS

The novel feature of the present invention are set forth in the appended claims. The invention will be best understood when reading the detailed description in conjunction with accompanying drawings wherein:

FIG. 1 illustrates a client connected to the Internet via a local provider;

FIG. 2 illustrates a client connected to a central server, where the central server is coupled to a plurality of providers;

FIG. 3 is a flow chart illustrating an embodiment of a provider selection in accordance with the present invention;

FIG. 4 is a flow chart illustrating an embodiment of a distributed phone in accordance with the present invention;

FIG. 5 is a flow chart illustrating a billing system corresponding to the embodiments in FIGS. 3 and 4;

FIG. 6 is a block diagram indicating the flow of information for the flow chart of FIG. 3; and

FIG. 7 is a block diagram indicating the flow of information for the distributed phone embodiment of FIG. 4.

### DESCRIPTION OF THE PREFERRED EMBODIMENT

Although those skilled in the art may apply variations to the present invention as characterized in the detailed description, such variations would fall within the scope of the present invention.

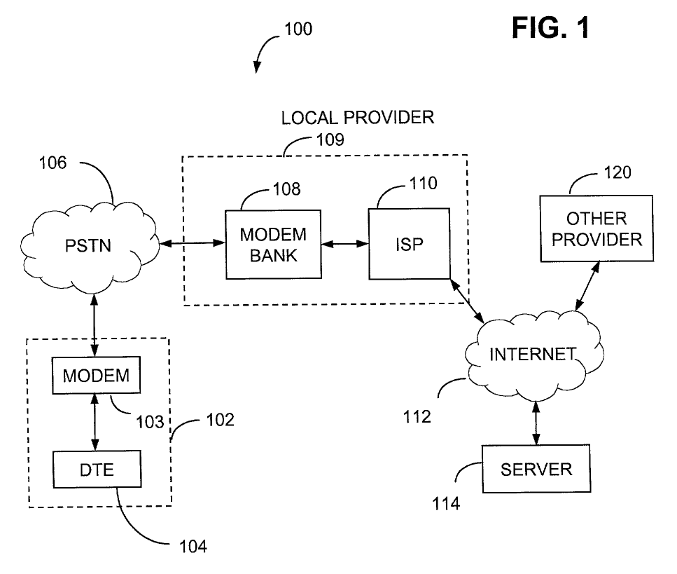

Referring now to FIG. 1 there is shown an arrangement 100 for connecting a client 102 to the Internet 112. The client 102 is a data terminal equipment (DTE)104 coupled to a dialup modem 103. Typically, the DTE 104 is a personal computer, but other devices would fall within the scope of the present invention. The modem is connected to the public switched telephone network (PSTN) 106 and then connected from the PSTN to a local provider 109. The local provider 109 has a modem bank 108 for exchanging data with the client dialup modem 103. Additional provider equipment 110 may include routers, servers, computers, and other devices. One or more providers 120 may also be connected to the Internet 112. A server 114 is coupled to the Internet 112 and is capable of information exchange with the client 102 and the one or more providers 120.

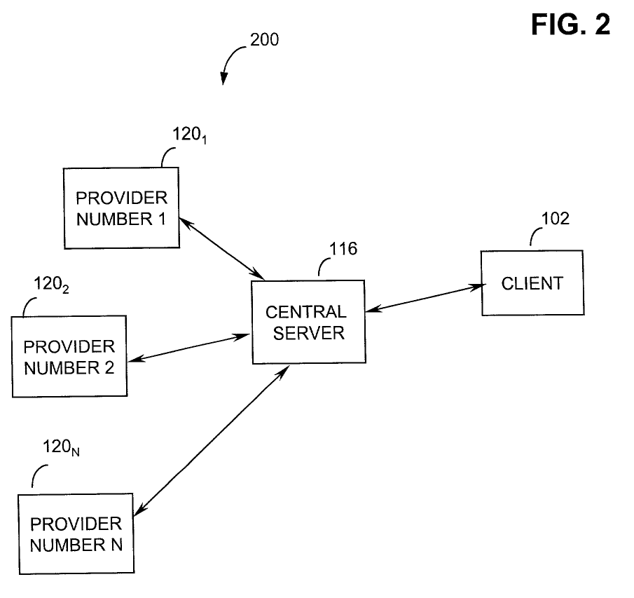

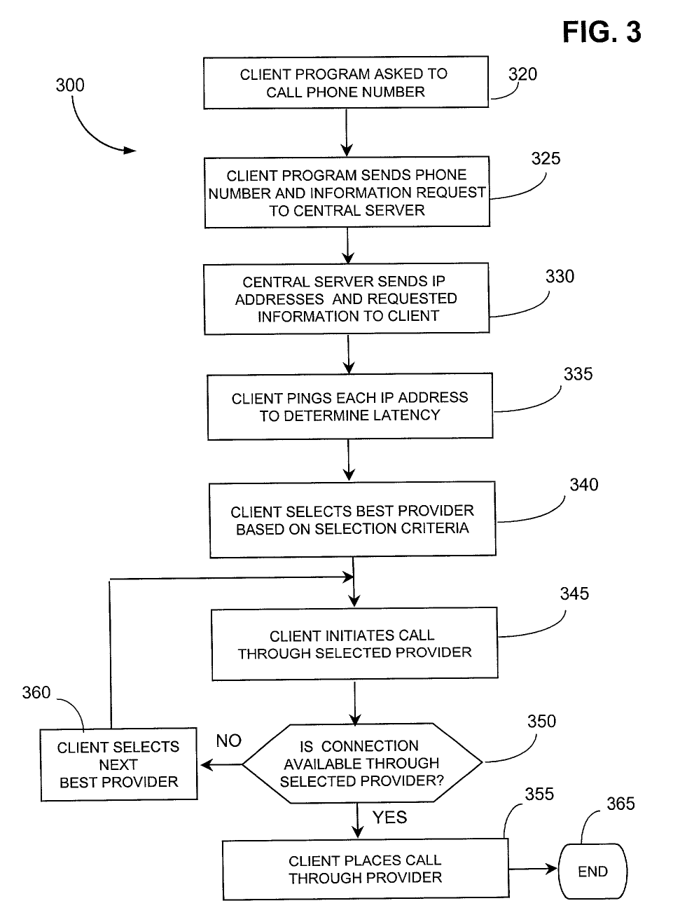

FIG. 2 illustrates a block diagram of an Internet voice system 200 in accordance with the present invention and includes a client 102, a central server 116, and one or more providers 120₁, 120₂, . . . , 120_{N} coupled together over a network (not shown). The client 102 has a program or logic to initiate an Internet voice connection. Each of the one or more providers 120 has elected to furnish to any entity, such as client 102, the use of the provider's bandwidth for voice services, such as telephone service. Each of the providers 120 has furnished to the central server 116 connection information, such as unit time cost, phone number patterns, times of availability and other information related to a selection criteria. Providers may update information at their convenience and may elect not to participant at any time. The exchange of information between the elements of FIG. 2 in order to establish a voice connection are best understood when viewing the flow chart of FIG. 3.

Flow chart 300 of FIG. 3 describes a method embodiment for establishing a phone connection over the Internet. First, step 320, a program in the client 102 is asked to call a phone number. The client program, step 325, sends the phone number and a request for information to the central server 116. The request for information may include unit cost values, expected latency, other performance parameters, name of provider, IP address of provider, etc. In response to the request, the central server 116 sends information to the client, step 330. The client may then ping each of the IP addresses to determine latency, step 335. The pinging process comprises sending a signal and measuring the response time from the IP address. When the client has sufficient information, the client utilizing a program or client logic, selects the best provider from the one or more providers, step 340. A nonlimiting example of a selection criteria would be to chose the provider that had the least latency and that had unit cost less than a specified value. The client then initiates a call to the phone number through the selected provider, step 345. Because step 345 is part of a loop, the term selected provider is used. For the first transition through the loop the selected provider is the best provider. Next decision step 350 allows for placing a call, the YES path and call placing step 355. If the connection to the selected provider is not available, the NO path of step 350, then the client selects the next best provider, step 360. The output of step 360 results in a second use of steps 345 and 350. The looping steps may be repeated as necessary until step 355 occurs. After the call is complete the process is complete and the end step 365 occurs.

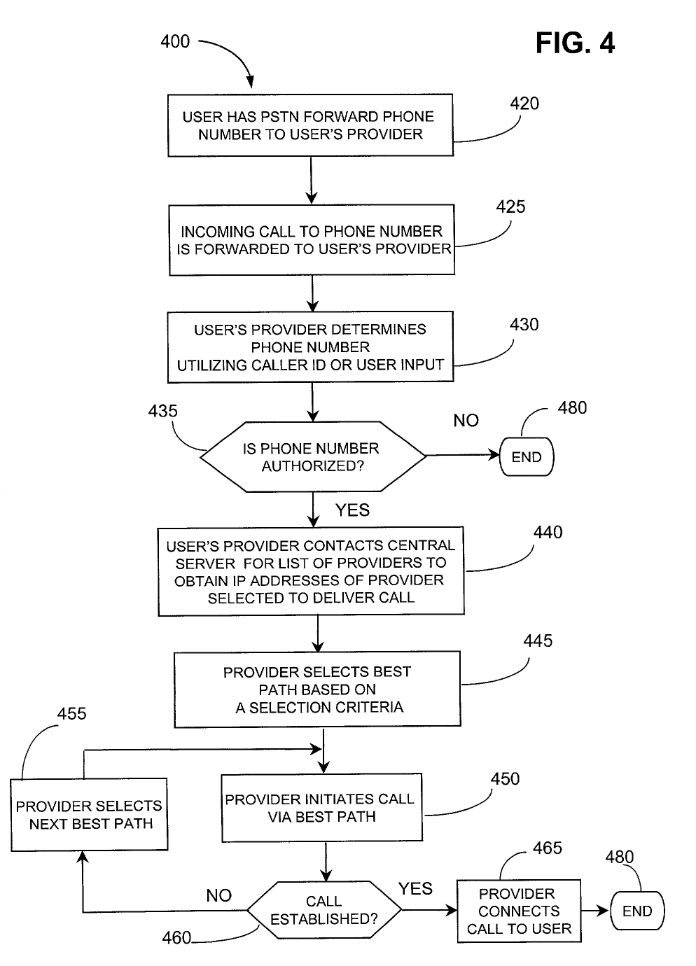

If a client desires to have a distributed phone-to-IP gateway 400, flowchart of FIG. 4 illustrates steps of an embodiment. First, the user forwards the user phone number to the user's provider, step 420. An incoming call, from another phone, is then directed to the user's provider, step 430. Next the user's provider determines the desired phone number using caller ID, step 430. If the phone number is not authorized, the NO path of decision step 435, the attempt ends 480. However, when the phone number is authorized the user's provider contacts the central server for a list of providers and other information, step 440. The user's provider selects the best path based on a selection criteria, step 445. The user's provider then initiates a call, step 450, using the best path. If a call cannot be established, the NO path of decision step 460, then the provider selects the next best path 455, and loops back through initiation step 450. If a call is established , the YES path of decision step 460, then a connection is provided to the user, step 465.

For the Internet voice system 200 of the present invention as further described in flow chart 300 and flow chart 400, it is desirable to provide a billing system or method that has the confidence of both customers (clients) and providers. Because the Internet voice system 200 may have a large number of providers and customers that are automatically connected, a billing system that guarantees the authenticity of billing records is desirable. Such a billing method should make it virtually impossible for a provider to bill for unplaced calls or for a customer to make unauthorized or unbilled calls.

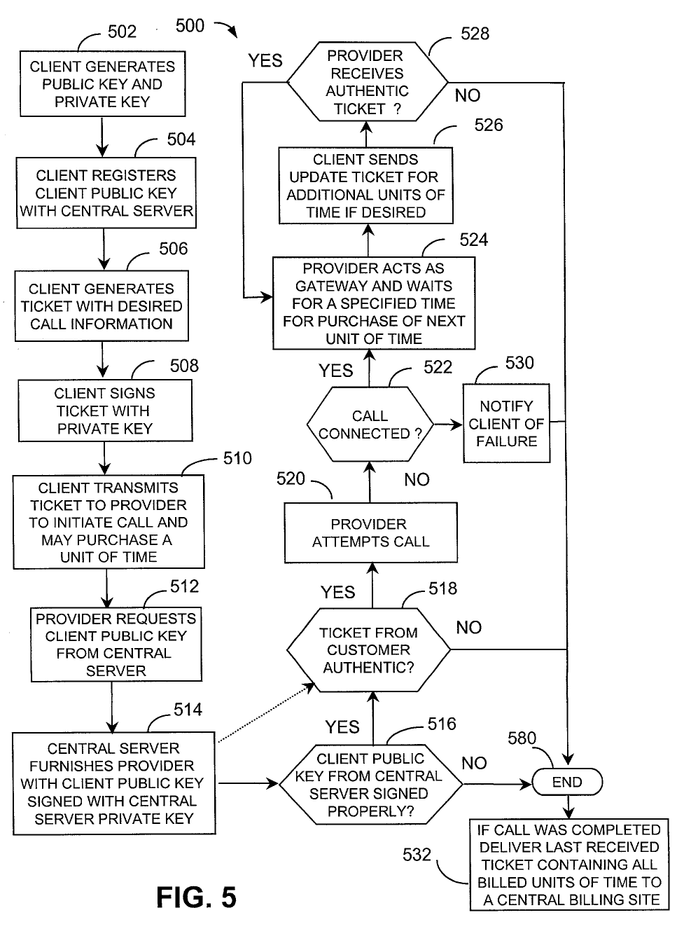

A disputeless billing system 500 illustrated in FIG. 5 meets the needs of customers and providers. The billing system is based on public and private key encryption, such as RSA encryption. Details of the RSA use of a private key and public key are well known. In a typical security application, a file encrypted using a public key associated with a private key is sent from a second party having the public key to a first party having the private key. Once a document is encrypted with the public key only a holder of the private key can view the encrypted file. For the disputeless billing system of the present invention, the client sends a ticket signed with a private key and the corresponding public key is used to verify the source, i.e., the user having the private key. This being said, consider now the steps of the disputeless billing system 500.

The client generates a client public key and a client private key, step 502. The client then registers the client public key with the central server 116, step 504. Next the client generates a ticket containing the desired call information such as calling party identification, terminating server, price, length of call purchased so far, start of call, call identifier, etc., step 506. The client signs the ticket with the client private key, step 508. The client transmits the ticket to the selected provider to initiate a call, step 510. Optionally, in step 510, the client may purchase a unit of time, thus initiating a “provider trust” billing arrangement. If, during step 510, the client does not purchase a unit of time, a “client trust” billing arrangement occurs. Next, the provider requests the central server send the client public key from, step 512. The central server furnishes the selected provider with the client public key that is signed with a central server private key, step 514. If the client key from the central server is signed properly, as verified against a copy of the central server public key at the provider site, the YES path of decision step 516 is taken. When YES path is taken, the ticket from the customer is checked for authenticity, step 518. If the client key from the central server is not signed properly, the NO path of decision step 516, the process terminates to end step 580. If the ticket from the customer is not authentic, the NO path of decision step 518, then the process terminates. If the ticket from the customer is authentic, the YES path of decision step 518, then the provider attempts to establish a call, step 520. If the call is not connected, the NO path of decisions step 522 causes the process to end, and the client is notified of failure, step 530. If a call is connected, then a billing loop for maintaining the connection is implemented, steps 524, 526 and 528. In step 524, the provider acts as a gateway and waits for a specified time for purchase of a next unit of time. While the gateway is waiting, the client sends an update ticket for additional units of time by increasing the total time field, step 526. If the provider receives an authentic ticket the YES path of decision step 528 is taken and the provider continues to wait for the purchase of a next unit of time, step 524. However, if the provider does not receive an authentic ticket, then the connection established by the provider is terminated, end step 580.

After a completed call ends, then no more units of time are purchased. At the end of a completed call the last received ticket, containing all the billing for units of time is sent to a central billing site where the ticket is verified against the client public key and where billing records are generated, step 532.

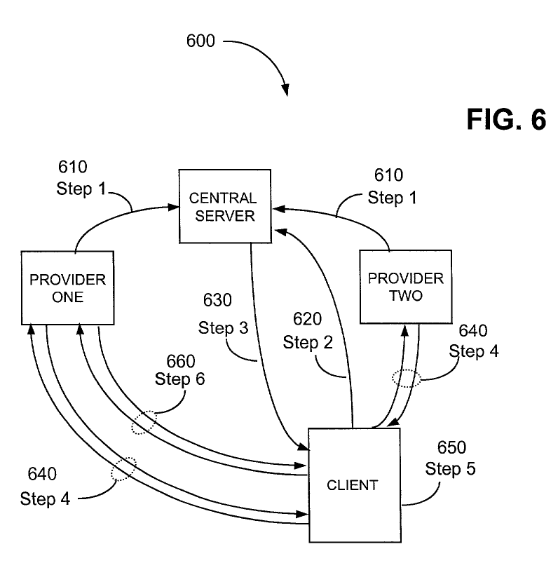

FIG. 6 illustrates the flow of information on a network connected to two providers 120, the client 102, and the central server 116. In the first step 610 each of the providers 120 sends information to the central server 116. After the central server has provider information, the client 102 provides a phone number to be called to the central server 116 and requests information, step 2 620. In step 3 630, the central server furnishes the client with a list of addresses and the requested information which may include items, such as phone patterns, unit time cost, availability times and other information. The client then pings each of the providers, step 4 640 to determine path latencies. A client program or logic then selects the best provider, step 5 650. In FIG. 6, the best provider is provider one. The client then establishes a voice connection through provider one, step 6 660. If provider one is not available then the next best provider is selected and the steps for providing a connection continue until a connection is made.

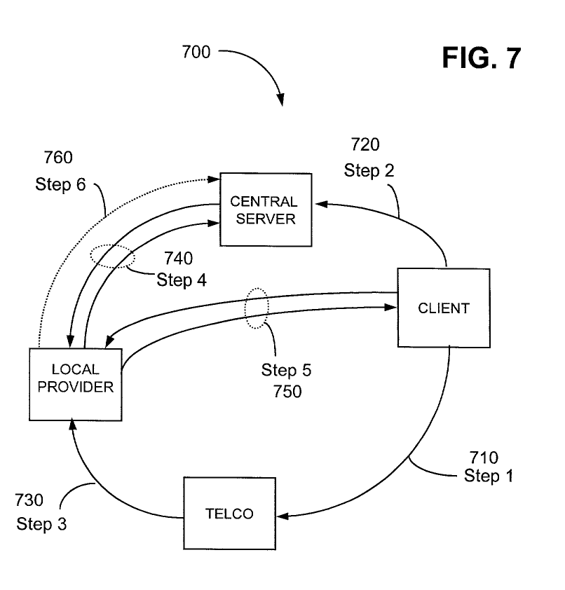

An embodiment of the distributed phone 500 is illustrated in FIG. 7 showing the steps and relationships between the client, telephone company, local provider, and central server. First, the user forwards the user's phone number to the local provider using the telephone company's forwarding service, step 1 710. The user's phone number is then sent from the client to the central server 116 and stored in a table, step 2 720. An incoming call to the user's phone number is forwarded to the local provider, step 3 730. The local provider then obtains information from the central server and determines if the user's phone number is authorized, step 4 740. The local provider, selecting a best provider, then serves as a voice gateway for the client and connects the call, step 5 750. If the best provider does not complete the call local provider contacts the central server for next best provider, step 6 760 to initiate a call over the next best provider.

From the foregoing, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

What is claimed is:

1. A method of providing a telephone connection to a phone number over a network from a client connected to the network, the method comprising the steps of:
sending the phone number and an information request from the client to a central server;
providing from the central server to the client, addresses of one or more providers and the requested information;
selecting in accordance with a selection criteria the best provider from the one or more providers; and
connecting a network voice path to the phone number through the address of the best provider.

2. The method of claim 1 wherein the selection criteria is based on latency and unit of time cost.

3. The method of claim 1 further comprising the step of pinging each of the addresses by the client after the providing step.

4. The method of claim 1 wherein a failure in the connecting step is followed by the step of selecting the next best provider and connecting to the next best provider.

5. The method of claim 1 where the network is the Internet.

6. An apparatus for providing a voice connection over a network from a client site, the apparatus comprising:
a data communication device at a client site for providing full duplex data transfers to the network, the data communication device adapted to request information from other devices on the network;
a central server coupled to the network and having logic for sending requested provider information related to one or more providers to the data communication device where provider information includes unit cost information and an address for each provider; and
selection logic within the client to determine the best provider.

7. The apparatus of claim 6 wherein the selection logic decision is based on latency and unit cost.

8. The apparatus of claim 6 wherein the network is the Internet.

9. The apparatus of claim 6 wherein the central server has a provider table for storing information about providers.

10. The apparatus of claim 9 wherein the provider table may be updated by each of the one or more providers.

11. A method of providing a voice connection over the Internet from a user site having a communication device, the method comprising the steps of:
entering a phone number in the communication device;
sending the phone number and a provider information request from the communication device to a central server;
providing from the central server to the communication device a list of one or more providers satisfying a pricing criteria;
pinging each of the one or more providers to determine latency;
selecting the best provider from the one or more providers where the dominant selection factor is unit cost with a selection algorithm a desired provider from the one or more providers; and
connecting an Internet voice path to the phone number through the desired provider.

12. A system for providing a voice connection over the Internet to one or more clients, the apparatus comprising:
a central server coupled to a network, the central server having a table of provider information where the table includes pricing information and phone number patterns, the central server further having a communication protocol for responding to inquiries from the one or more clients; and
client logic for requesting information from the central server and for selecting a best provider.

13. A method for providing phone service to a client over a network including a billing process, the method comprising the steps of:
requesting, by the client, provider information about one or more providers from a central server, where each of the providers is capable of connecting to a phone number furnished by the client;
determining from the provider information and latency measurements the best provider from the one or more providers;
sending a ticket signed by a client private key to the best provider; and
verifying with a client public key the validity of the ticket.

14. The method of claim 13 further comprising the step of:
forwarding the valid ticket to the central server.

15. The method of claim 14 where the forwarding step comprises the steps of:
signing, at the central server, the client public key with a server private key; and
verifying with a previously obtained server public key the validity of the client public key.

16. A system for providing a voice connection over a network, the system comprising:
one or more providers connected to the network, the providers having provider information related to the voice connection;
a central server connected to the network and having a table for storing and updating provider information, the central server having server logic for filtering provider information; and
a client adapted to initiate a voice call to a phone number and to request and to receive filtered provider information from the central server, the client having client logic for determining the best provider and for establishing a voice connection through the best provider to the phone number.

17. A method of providing distributed phone service over the Internet, the method comprising the steps of:
forwarding a user phone number to a user provider;
verifying that the user phone number is authorized for the distributed phone service and retrieving the forwarding number;
contacting, by the user provider, a central server having a list of one or more providers willing to deliver a connection to the forwarding number; and
selecting a best provider from the one or more providers and establishing a connection via the best provider.

18. The method of claim 17 comprising the additional step of:
billing the user for the call after the call has ended.

19. A system for providing disputeless billing for network phone service to a client over a network including having a central server and a provider, the system comprising the steps of:
generating a client private key and a client public key;
sending a ticket signed by the client private key to the provider; and
verifying by the provider, using the client public key, that the ticket is valid.

20. A system for providing disputeless billing for network phone service to a client over a network including having a central server and a provider, the system comprising the steps of:
generating a client private key and a client public key;
registering the client public key with the central server;
transmitting a ticket signed by the client private key to the provider;
requesting, by the provider to the central server, the client public key;
furnishing the provider the client public key; and
verifying by the provider, using the client public key, that the ticket is valid.

21. A system for providing disputeless billing for network phone service to a client over a network including having a central server and a provider, the system comprising the steps of:
generating a client private key and a client public key;
registering the client public key with the central server;
transmitting a ticket signed by the client private key to the provider;
requesting, by the provider to the central server, the client public key;
signing, at the central server, the client public key with a central server private key and sending results to the provider;
verifying by the provider, using the server public key, that the client public key is valid; and
verifying by the provider, using the client public key, that the ticket is valid.
